(19) United States
(12) Patent Application Publication
(10) Pub. No.: US 2015/0339602 A1
(43) Pub. Date: Nov. 26, 2015

(54) SYSTEM AND METHOD FOR MODELING HEALTH CARE COSTS

(71) Applicant: OSCAR INSURANCE CORPORATION, New York, NY (US)

(72) Inventors: Mario Schlosser, New York, NY (US); John Loser, New York, NY (US)

(21) Appl. No.: 14/328,774

(22) Filed: Jul. 11, 2014

Related U.S. Application Data
(60) Provisional application No. 62/002,012, filed on May 22, 2014.

(51) Int. Cl. G06Q 10/06; G06F 19/00; G06Q 50/24

(52) U.S. Cl. CPC G06Q 10/0631; G06Q 50/24; G06F 19/3437; G06F 19/325; G06F 19/327

(57) ABSTRACT

Systems and methods for generating models of potential medical treatment pathways are provided. In some embodiments, the systems and methods determine estimated costs of medical treatment responsive to user input of medical conditions. Some embodiments generate candidate treatment pathways from historic medical claim information. The candidate treatment pathways can be based on a channel of care and a medical condition. Further embodiments determine a probability associated with a treatment pathway and determine potential costs for the treatment pathway within a respective channel of care for a medical condition. In some examples, the system provides cost estimates within each channel and/or for each treatment pathway. In other examples, the system can also identify a likelihood associated with each treatment pathway, assign weights based on occurrence, and calculate the costs for treatment paths using the calculated weights and, for example, location of service.

### RELATED APPLICATIONS

This application claims priority under 35 U.S.C. §119(e) to U.S. Provisional Application Ser. No. 62/002,012, entitled “SYSTEM AND METHOD FOR MODELING HEALTH CARE COSTS,” filed May 22, 2014, which application is herein incorporated by reference in its entirety.

### BACKGROUND

Universal health insurance coverage is becoming more widespread across the global community. Conventional wisdom suggests that with better insurance coverage, greater utilization of medical services will follow. Various systems and applications attempt to serve the needs of the growing population of consumers of medical services. For example, some conventional systems link patients to doctors or allow patients to select from groups of doctors that may be suited to their needs based on collecting and providing access to user recommendations. Other conventional systems provide user based doctor ratings and/or combine user based ratings with third party rating systems to deliver information on which consumers can assess the multitudes of available service providers (e.g., doctors, nurse practitioners, physician assistants, medical practices, etc.).

### SUMMARY

It is realized that there is a need to provide medical consumers the ability to review costs and estimates by provider for the medical services. Accordingly, various aspects of the disclosure are directed to analyzing historic medical service records and generating predictive models for treatment. Stated broadly, some embodiments of a system and method for estimating health care costs generate probabilistic models for potential channels of care (e.g., primary care physician (“PCP”), specialists, emergency room, pharmacy, etc.) and potential medical services that would be needed for a medical condition. Upon accessing such a system, users can evaluate their potential costs and/or service provider options to select the appropriate medical treatment for their needs. The system can present and organize treatment options for users according to a channel of care. A channel of care represents a potential medical service provider or facility (e.g., doctor, Emergency Room, etc.). Within each channel of care, a variety of medical services may be offered to treat a patient's medical condition. The services delivered form a treatment path, which can be as simple as a doctor visit to prescribe antibiotics or as complex as a PCP visit, referral to a specialist, imaging, surgery, recovery, and post-operative home visits.

According to one aspect, the system is configured to develop a statistical distribution of medical treatment paths, for example, within channels of care from historic medical claims data. The system can be configured to organize and disambiguate the historic data so that users can be provided cost estimates for any input medical condition.

According to one embodiment, the system presents user interfaces configured to be responsive to user entered symptoms and/or medical conditions. In some examples, the user interfaces accept search criteria for conditions to deliver classifications of channels of care along with estimates of costs associated with each channel. In further examples, the system can provide cost estimates within each channel of care based on the probability a medical service will be needed within that channel of care (e.g., PCP visit $50 (likely), PCP visit plus lab test $550 (rare), etc.). According to another embodiment, the system identifies candidate treatment options within each channel of care that are displayed responsive to user searches on medical conditions. In one example, users can also access geographic displays of candidate providers available within each channel by selecting within a particular channel of care. For example, candidate PCPs can be displayed in a map responsive to the current user's location or profile address.

According to another aspect, systems and methods for estimating health care costs manage historic medical claim records to generate manipulatable data. Various systems and methods disclosed analyze medical claim information and compress the historic data into unique days of service where each unique day of service is tied to a medical provider. According to one embodiment, mapping the historic claim information into unique days of service enables probabilistic modeling of treatment information based on channel of care and condition. In further embodiments, within the channel of care and condition, possible treatment paths are generated by the system from the historic data. The system uses the defined treatment paths to determine a likelihood that a combination of medical services within a channel of care will be needed for a given condition.

According to one aspect, a system for estimating health care costs is provided. The system comprises at least one processor operatively connected to a memory, an analysis component, executed by the at least one processor, configured to determine weight values associated with one or more treatment options from historical medical information, and to generate one or more treatment paths, each treatment path including one or more treatment options, and a calculation component, executed by the at least one processor, configured to calculate an estimated cost associated with the one or more treatment options, based on, at least in part, the weight values and the one or more treatment paths.

According to one embodiment, the analysis component is further configured to identify the one or more treatment paths including the one or more treatment options based on grouping medical condition information with the one or more treatment options. According to one embodiment, the analysis component is further configured to rank the one or more treatment paths based on a respective probability that the medical condition information requires the treatment option. According to one embodiment, the analysis component is further configured to assign the historic medical information to an episode of care, and within each episode of care, and to assign the historic medical information to unique days of service. According to one embodiment, the analysis component is further configured to identify the one or more treatment paths based, at least in part, on the unique days of service. According to one embodiment, wherein the analysis component is further configured to associate the historic medical information to a channel of care and a medical condition. According to one embodiment, wherein the analysis component is further configured to identify the one or more treatment paths based, at least in part, on the channel of care and the medical condition.

According to one embodiment, the system further comprises a database of medical claims and medical condition information. According to one embodiment, the database of the medical claims and the medical condition information is organized based on a medical condition, a channel of care, and a treatment fingerprint. According to one embodiment, the calculation component is further configured to calculate the estimated cost based on the weight values applied to an insurance provider fee schedule. According to one embodiment, the calculation component is further configured to generate a plurality of treatment options based on an association between a medical condition entered by the user and a treatment option. According to one embodiment, the calculation component is further configured to generate the estimated cost associated with the one or more treatment options as a range of costs associated with a channel of care.

According to one embodiment, the calculation component is further configured to generate the estimated cost for a plurality of channels of care. According to one embodiment, the calculation component is further configured to generate the estimated cost for a plurality of respective treatment paths within each of the plurality of channels of care.

According to another aspect, a computer implemented method for estimating health care costs is provided. The method comprises determining, by a computer system, weight values associated with one or more treatment options from historical medical information, generating, by the computer system, one or more treatment paths, each treatment path including one or more treatment options, and calculating, by the computer system, an estimated cost associated with the one or more treatment options, based on, at least in part, the weight values and the one or more treatment paths.

According to one embodiment, generating the one or more treatment paths, each treatment path including one or more treatment options, includes generating the one or more treatment paths based on grouping medical condition information with the one or more treatment options. According to one embodiment, the method further comprises ranking the one or more treatment paths based on a respective probability that the medical condition information requires the treatment option. According to one embodiment, the method further comprises assigning the historic medical information to an episode of care, and within each episode of care assigning the historic medical information to unique days of service. According to one embodiment, the method further comprises identifying the one or more treatment paths based, at least in part, on the unique days of service.

According to one embodiment, the method further comprises associating the historic medical information to a channel of care and a medical condition. According to one embodiment, identifying the one or more treatment paths includes identify the one or more treatment paths based, at least in part, on the channel of care and the medical condition. According to one embodiment, the method further comprises accessing a database of medical claims and medical condition information. According to one embodiment, the method further comprises organizing the medical claims and the medical condition information within the database based on a medical condition, a channel of care, and a treatment fingerprint. According to one embodiment, the method further comprises calculating the estimated costs based on the weight values applied to an insurance provider fee schedule. According to one embodiment, the method further comprises generating a plurality of treatment options based on an association between a medical condition entered by the user and a treatment option. According to one embodiment, calculating, by the computer system, the estimated cost associated with the one or more treatment options includes generating the estimated cost associated with the one or more treatment options as a range of costs associated with a channel of care.

According to one embodiment, calculating, by the computer system, the estimated cost associated with the one or more treatment options includes generating the estimated cost for a plurality of channels of care. According to one embodiment, calculating, by the computer system, the estimated cost associated with the one or more treatment options includes generating the estimated cost for a plurality of respective treatment paths within each of the plurality of channels of care.

According to another aspect, a system for delivering health care cost estimates is provided. The system comprises at least one processor operatively connected to a memory, a search component, executed by the at least one processer, configured to receive user input medical condition information, to identify matching channels of care, and to retrieve associated cost estimates for respective channels of care, and a user interface (“UI”) component, executed by the at least one processer, configured to display a search interface to a user, to communicate the user input symptom information to the search component, to display the associated cost estimates and the respective channels of care, and to organize the display based on the respective channels of care.

According to one embodiment, the UI component is further configured to organize the display of the associated cost estimates into expandable views for each channel of care. According to one embodiment, the UI component is further configured to transition the display of the associated cost estimates between a first view displaying a cost estimate for a channel of care and a second view displaying treatment pathways within the channel of care responsive to user selection within the display. According to one embodiment, the second view includes a cost estimate associated with each treatment pathway within the channel of care and a respective probability that the treatment pathway occurs. According to one embodiment, the UI component is further configured to rank order the second view based, at least in part, on the respective probability the treatment pathway occurs. According to one embodiment, the UI component is further configured to display a plurality of providers within a channel of care selected from the display of the associated cost estimates and the respective channels of care. According to one embodiment, the UI component is further configured to display the plurality of providers in a map based interface relative to a user associated location.

According to one embodiment, the search component is further configured to receive user filter criteria within a selected channel of care. According to one embodiment, the search component identifies matching care providers responsive to the user entered filter criteria. According to one embodiment, the system further comprises a calculation component, executed by the at least one processor, configured to calculate an estimated cost associated with one or more treatment options from historic medical information. According to one embodiment, the calculation component is further configured to determine the estimated cost associated with the one or more treatment options based on, at least in part, weight values, a projected treatment path, and a user associated location. According to one embodiment, the calculation component is further configured to determine the estimated cost associated with the one or more treatment options based on, at least in part, a user selected medical provider.

According to another aspect, a computer implemented method for delivering health care cost estimates is provided. The method comprises receiving, by a computer system, user input medical condition information entered in a user interface, identifying, by the computer system, matching channels of care, retrieving, by the computer system, associated cost estimates for respective channels of care, displaying, by the computer system, the associated cost estimates and the respective channels of care, and organizing, by the computer system, the display of the associated cost estimates based on the respective channels of care.

According to one embodiment, the method further comprises organizing the display of the associated cost estimates into expandable views for each channel of care. According to one embodiment, the method further comprises transitioning the display of the associated cost estimates between a first view displaying a cost estimate for a channel of care and a second view displaying treatment pathways within the channel of care responsive to user selection within the display. According to one embodiment, the method further comprises displaying responsive to transitioning to the second view a cost estimate associated with each treatment pathway within the channel of care and a respective probability that the treatment pathway occurs. According to one embodiment, the method further comprises ordering the second view by rank based, at least in part, on the respective probability the treatment pathway occurs. According to one embodiment, the method further comprises displaying a plurality of providers within a channel of care responsive to user selection in the display of the associated cost estimates and the respective channels of care.

According to one embodiment, displaying a plurality of providers includes displaying the plurality of providers in a map based interface relative to a user associated location. According to one embodiment, the method further comprises receiving user filter criteria within a selected channel of care from the user interface. According to one embodiment, the method further comprises identifying matching care providers responsive to the user entered filter criteria.

According to one embodiment, the method further comprises calculating, by the computer system, an estimated cost associated with one or more treatment options from historic medical information. According to one embodiment, calculating the estimated cost includes determining the estimated cost associated with the one or more treatment options based on, at least in part, weight values, a projected treatment path, and a user associated location. According to one embodiment, calculating the estimated cost includes determining the estimated cost associated with the one or more treatment options based on, at least in part, a user selected medical provider.

Still other aspects, embodiments and advantages of these exemplary aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by reference signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral.

For purposes of clarity, not every component may be labeled in every figure. The figures are provided for the purposes of illustration and explanation and are not intended as a definition of the limits of the invention. In the figures:

FIG. 1 is a block diagram of an example estimation system, according to one embodiment;

FIG. 2 is a directed graph of potential treatment options and probability of treatment options, according to one embodiment;

FIG. 3 is a block diagram of an example environment for an estimation system, according to one embodiment;

FIG. 4 is an example process for delivering medical service estimates responsive to user entered condition, according to one embodiment;

FIG. 5 is an example process for classifying medical claims information, according to one embodiment;

FIG. 6 is an example process for determining a likelihood associated with possible treatment paths, according to one embodiment;

FIG. 7 is an example process for estimating costs of possible treatment paths, according to one embodiment;

FIGS. 8A-C are example user interfaces for displaying and interacting with medical cost estimate information, according to one embodiment;

FIG. 9A-E are example user interfaces for displaying and interacting with medical cost estimate information, according to one embodiment;

FIG. 10 is an example user interface for displaying and interacting with medical cost estimate information, according to one embodiment;

FIG. 11A-D are example user interfaces for displaying and interacting with medical cost estimate information, according to one embodiment;

FIGS. 12-13 are example user interfaces for displaying and interacting with medical cost estimate information, according to one embodiment; and

FIG. 14 is a block diagram of a general purpose computer system, on which various aspects and embodiments can be executed.

### DETAILED DESCRIPTION

Stated broadly various aspects and embodiments are directed to systems and methods for generating models of potential medical treatment pathways. In some embodiments, the systems and methods determine estimated costs of medical treatment responsive to user input of medical conditions. Some embodiments are configured to generate candidate treatment pathways from historic medical claim information. The candidate treatment pathways can be based on a channel of care (e.g., type of provider (e.g., PCP, specialist, ER, hospital, etc.)) and a medical condition. Further embodiments determine a probability associated with a treatment pathway and determine potential costs for the treatment pathway within a respective channel of care for a condition. In some examples, the system provides cost estimates within each channel for each treatment pathway. In other examples, the system can also identify a likelihood associated with each treatment pathway, assign weights based on occurrence, and calculate the costs for treatment paths using the assigned weights and, for example, location of service.

According to other aspects, it is further realized that medical care cannot proceed without a provider. Thus, the system defines logical data units in terms of a unique provider visit from which any number of medical treatments can proceed. In some embodiments, unique days of service data objects are defined and stored by the system based on aggregating medical information having a common originating medical provider. Subsequent tests, procedures, visits, etc., are stored in association with the unique day of service data object. The unique day of service can also be used to define a treatment fingerprint for a treatment pathway. In some embodiments, the data objects can be analyzed to determine probabilities associated with a given treatment path. In further embodiments, the probabilities can be applied to known treatment costs to project cost ranges for a channel of care, and for example, to provide more specific projections of cost for treatment options within each channel.

The examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

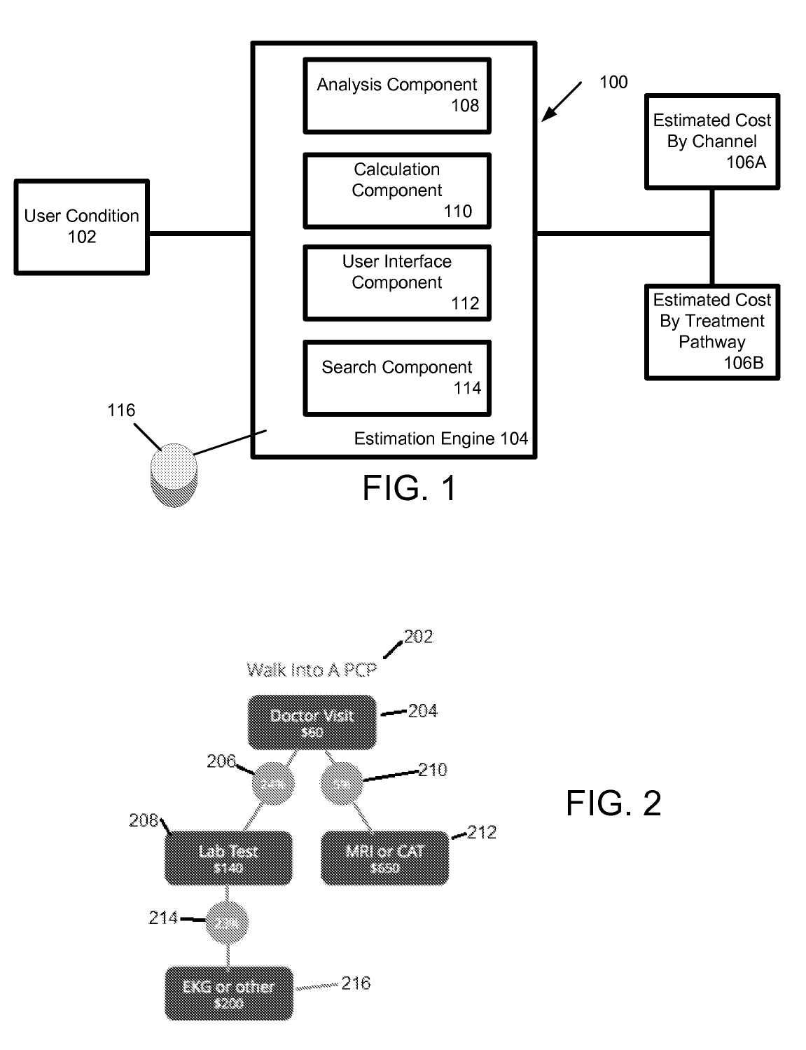

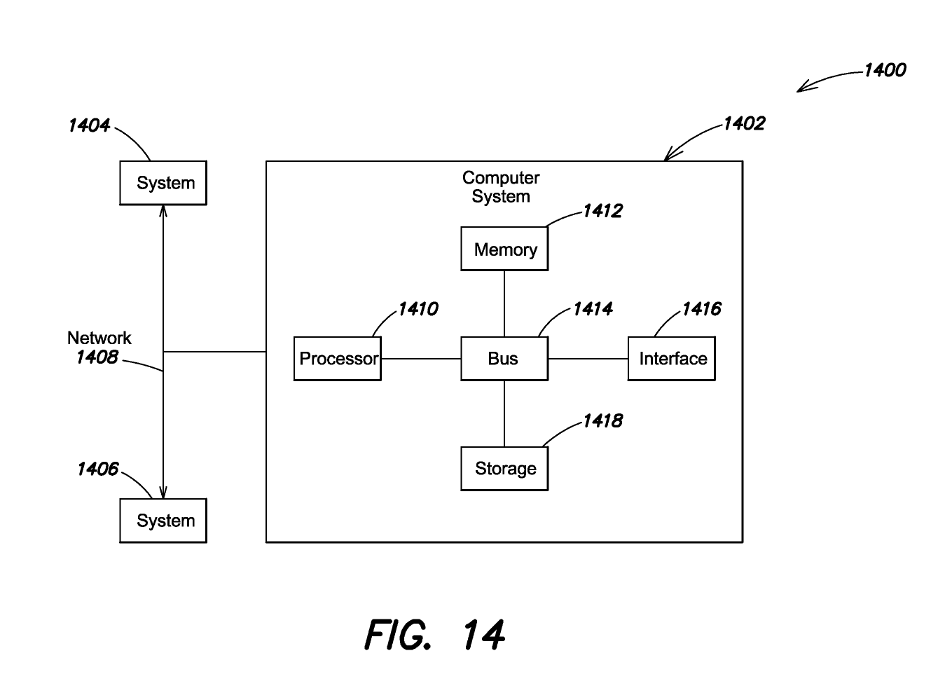

FIG. 1 is a block diagram of an example system 100 for estimating medical costs. According to one embodiment, the system 100 can include an estimation engine 104 for executing the functions and operations discussed with respect to system 100. In other embodiments, the system 100 and/or engine 104 can include or instantiate other system components for performing specific functions or operations. In some examples, the system 100 and/or engine 104 can be executed on a general purpose computer system (e.g., system 1400 or 1402 discussed below with respect to FIG. 14).

The system 100 and/or engine 104 can be configured to receive user input on a medical condition (e.g., 102). Responsive to the user input (e.g., 102), the system and/or engine 104 can be configured to determine channels of care that match the input medical condition. Channels of care can include any facility and/or practitioner who can provide a treatment option to a patient having the input medical condition. According to one embodiment, the system 100 and/or engine 104 are configured to determine a treatment path (e.g., the medical service or service needed to resolve the medical condition) and display estimated costs associated with the channel of care based on the respective treatment paths within that channel (e.g., 106A). In other embodiments, the system can generate displays of estimated costs within each channel for the respective treatment pathways (e.g., 106B).

According to one embodiment, the system 100 and/or engine 104 can be configured to access historic medical claims data to generate treatment models based on, for example, channel of care, medical condition, and medical services rendered. In some examples, the system can access medical claims data stored in a medical claims database (e.g., 116), which provides historic information on channel of care, medical condition, and medical service rendered. The medical services rendered define a potential treatment pathway for a respective medical condition within a channel of care. Each treatment pathway includes all the services rendered to a patient having a medical condition until the medical condition is resolved.

In one embodiment, the system and/or engine 104 includes an analysis component 108 configured to analyze the medical claims information stored in database 116. The analysis component 108 can be configured to classify historic medical claims data into channels of care, medical condition, and medical services rendered for the medical condition. Further, the analysis component 108 can group medical claims into episodes of care to facilitate cost estimates. In other embodiments, the system can access a medical claims dataset that is already organized into channels and episodes of care.

According to one aspect, related medical claims are grouped into medical episodes so that a series of medical services can be associated with one episode (e.g., one episode identifier) even if the medical services are delivered over a course of time. For example, if a patient tears their anterior cruciate ligament (“ACL”), the episode of care includes all claims from the initial doctor visit, to radiology (e.g., x-ray and/or imaging), to surgery, any in-patient stay, and rehabilitation.

According to another aspect, the system 100, engine 104, and/or analysis component 108 can be configured to compress the data associated with the episode into one or more data objects representing a unique day of service. According to one example, the unique day of service data can be illustrated as a directed graph of any medical service provided for a medical condition originating with a medical provider encounter. In the graph, the nodes represent a service and the edges provide a probability that the service will be rendered. Each potential path through the graph (e.g., from a root to a node) corresponds to a treatment pathway.

FIG. 2 shows one example of a unique day of service mapping for a patient having a headache. In FIG. 2, the medical provider encounter is shown at 202 “Walk into a PCP.” More generically, the medical provider encounter can be described as a “Doctor Visit” at 204 under a PCP channel of care (e.g., 202). According to one example, all options under the channel PCP include a doctor visit, thus “Doctor Visit” is used as the root of the directed graph. At 206, a probability that a lab test 208 is executed for the medical condition headache is shown as 24%, and at 210 a 5% probability exists that a PCP will order an MRI or CAT scan at 212 for a patient having a headache. If the PCP ordered a lab test 208, a treatment path can include an EKG or other test in 23% of those cases, shown at 214 and 216 respectively. Each node (e.g., 204, 208, 212, and 216) in the graph represents a potential treatment path for the medical condition headache.

In some embodiments, the data is organized into associations between medical condition, channel of care, and treatment options by the analysis component 108. According to one embodiment, the analysis component 108 can be configured to define treatment fingerprints based on the presence or absence of a treatment option within an episode of care. In one example, the analysis component 108 is configured to store a binary representation of treatment information according to whether categories of treatment information are present for an episode of care. The categories of treatment information can include, for example, information on the presence of anesthesia, major surgery, minor procedure, ambulatory/outpatient procedure, imaging (e.g., x-ray), advanced imaging (e.g., CT, MRI), other imaging, lab test, functional test (e.g., EKG, stress test), durable medical equipment, and a general category for anything else within an episode of care.

According to various embodiments, the analysis component 108 can be configured to determine probabilities associated with the identified treatment paths, and determine cost weighting based on the occurrence of the identified treatment paths. The system 100 and/or engine 104 can be configured to determine an expected cost by channel of care using the cost weighting and identified treatments in the historic data. According to one embodiment, the system and/or engine 104 can include a calculation component 110 configured to determine the expected cost associated with a medical condition by channel of care. In further embodiments, the calculation component 110 is configured to generate average costs for a medical condition and treatment path according to a location of service. In some examples, the calculation component is configured to determine the average cost using the cost weights determine by the analysis component.

In some embodiments, the system 100 and/or engine 104 includes a user interface (“UI”) component 112 configured to display cost estimates organized by channel of care to an end user. In further embodiments, the user can interact with the user interfaces generated by the UI component 112 to enter symptoms or medical conditions and return information on estimated costs (e.g., produced by the calculation component 110). According to one embodiment, the UI component 112 is configured to display a search box for user input of symptom and/or medical condition information. Responsive to receiving the user input, a search component 114 can be configured to match the user input to channels of care and potential treatment pathways. In further embodiments, the search component 114 can also be configured to match medical service providers (e.g., PCP, specialists, etc.) qualified to provide the treatment pathways identified for an input medical condition. In some examples, the search component 114 can employ location information to filter the search and/or search results to medical service providers proximate to the user. In one example, the location information can be obtained from a user profile. In other examples, users can access the system through web browsers, and the web browser can provide location information on the user.

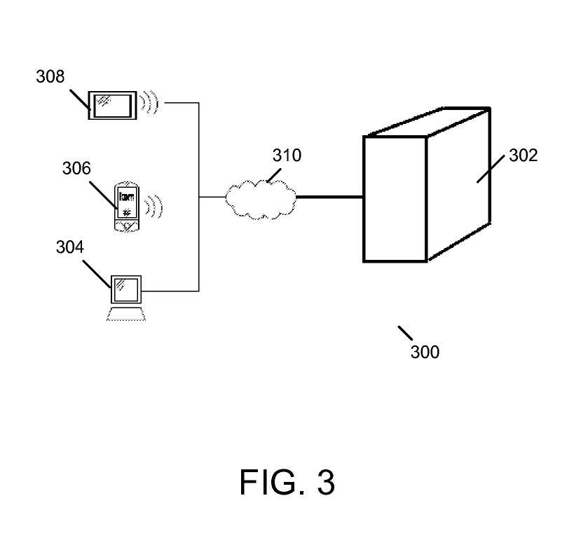

FIG. 3 is a block diagram 300 of an example environment including a system for estimating medical costs 302. In some embodiments, the system 302 can host an online presence (e.g., web pages) accessible by users on respective computing devices (e.g., desktop computer system 304, mobile device 306, and tablet 308). Users can access the system 302 by connecting to the online presence over a communication network 310. The communication network 310 can include local area networks (“LANs”), wide area networks (“WANs”), virtual private networks (“VPNs”), etc. In other embodiments, different communication architectures can be employed to allow users to access the system and obtain information on estimated medical costs.

According to one embodiment, the system executes a number of processes in order to capture medical condition information from a user, generate channel of care and treatment options that match the input medical condition information, and determine costs associated with a channel of care and any treatment option. According to other embodiments, the system can include an estimation engine configured to execute the processes required. In further embodiments, the system and/or engine can include additional system components that execute the processes, for example, to capture medical condition information from a user, generate channel of care and treatment options that match the input medical condition information, and determine costs associated with a channel of care and any treatment option.

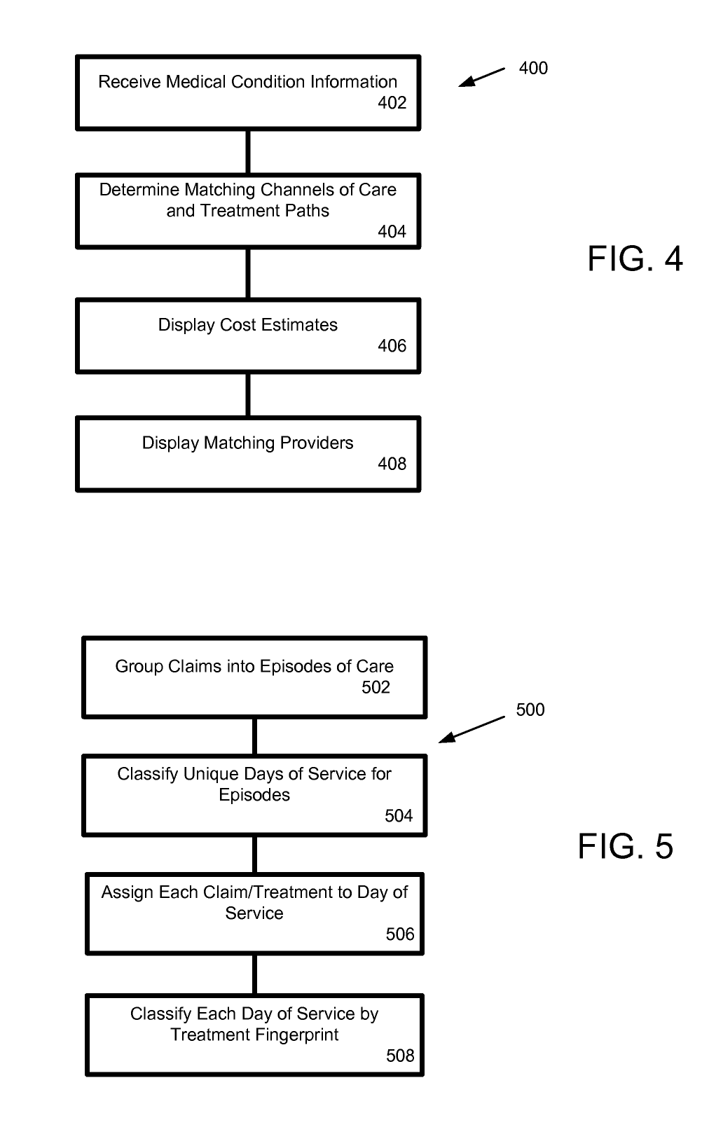

FIG. 4 is an example process 400 for providing cost estimates. Process 400 begins with receiving medical condition information at 402. For example, a user can access a website, input medical condition information (e.g., headache) in a search tool displayed on the site. The user input can be received at 402. Searching on the medical condition information is performed, and matching channels of care and potential treatment paths are determined at 404. In some embodiments, the searches are performed on historic medical claims information. Although not part of process 400, the historic medical claims information can be processed in order to provide accurate matches between channels of care/potential treatment options and user input medical condition information (e.g., discussed in greater detail below with respect to processes 500 and 600).

Once matching information is determined at 404, cost estimates are generated for display at 406. Displaying cost estimates at 406 can include execution of other processes to determine the estimated costs based on a matching channel of care and matching treatment paths (e.g., discussed in greater detail below with respect to process 700). The cost estimates can be provided for each channel of care, and may also include specification of an estimate for each potential treatment path. Process 400 can continue at 408, with display of medical providers who are capable of delivering the medical service associated with a displayed channel of care and treatment path. For example, a user can select “visit a primary care physician” as their desired channel of care. In response, the user is presented a location based display of primary care physicians who can treat the medical condition on which the user searched. According to some embodiments, displaying cost estimates at 406 can be further refined based on a determination of matching providers at 408. In some embodiments, process 400 can include additional steps (not shown) for refining cost estimates based on the matching providers from 408. Cost estimates can be calculated for each matching provider and displayed within information on the respective providers.

According to various embodiments, process 400 can be executed by an estimation system (e.g., 100 and 302), an estimate engine (e.g., 104), and/or specialized system components (e.g., 108, 110, 112, and 114). As discussed above process 400 can include or use information derived from other processes.

FIG. 5 is an example process 500 for classifying medical claims information. In some embodiments, an estimation system (e.g., 100 and/or 302) can process historic claims information to enable estimation of costs responsive to user input. In other embodiments, an estimation engine and/or an analysis component can be configured to process and classify existing claims information, for example, by executing process 500.

Process 500 begins at 502, with grouping of medical claims into episodes of care. Various approaches can be executed to group specific claims into an episode of care. In some embodiments, grouping operations are executed to tag each claim in a medical claims database with a respective episode ID. The grouping operations are executed to parse medical claims information and assign separate claims to a group based on the claims occurring as part of the same medical treatment process. For example, if a patient tore his ACL and got it repaired, the episode of care would include all claims from the initial doctor visit, to radiology claims, to the surgery and inpatient stay, and may include an eventual follow-up visit. Various clustering and/or grouping algorithms can be executed as part of 502 to organized claim information into episodes of care.

At 504, the process classifies unique days of service within each episode of care. According to some embodiments, the medical claims data is reduced and/or compressed into data objects that can be analyzed directly to derive probabilities associated with potential treatments. For example, at 504 each episode of care is compressed into “unique days of service.” Conceptually, a large number of medical episodes have claims that occurred on different days but actually belong together a part of an overall treatment path. As medical care cannot happen without a medical provider triggering it—logically, each medical claim can be associated back to an actual provider encounter. In other words, an episode's “unique days of service” are those dates during an episode on which a patient actually interacted with a medical provider. Compressing in 504, can include mapping all medical claims that occur on subsequent days back to a unique day of service. For example, a radiology visit (e.g., an MRI) that occurs on the day after a doctor's visit would be associated back to the preceding doctor visit, because that doctor most likely ordered the MRI.

In one embodiment, a unique day of service is defined by the presence of a professional visit on that day. A professional visit is identified from claims data by mapping a claim's identifying codes into standard classifications, and using the standard classification to determine a medical professional is associated with the claim. In one example, claims data having “current procedural terminology” codes (“CPT”) are identified and mapped into “Berenson-Eggers Type of Service” codes (“BETOS”). In one example, mapping into the BETOS codes enables lookup identification of the medical professional associated with the claim. In further examples, BETOS claims of type M (“management”) are used to identify an association with a medical provider. Matches on the management type claims can be filtered based on BETOS codes of M5A (pathology) and M5D (injection administration) to exclude the pathology and injection matches from association with professional visits.

According to some embodiments, each unique day of service is classified by a respective channel of care. According to one aspect, subsequent calculation of cost estimates are based on the channel of care that patient chooses: costs for the same medical condition are very different depending on whether a PCP, a specialist, an urgent care clinic or even an emergency room handles the care. Thus, each unique day of service can be classified with its channel of care.

According to some embodiments, a plurality of channels of care can be defined for medical services. In one example, the channels of care are defined to include any one or more of: in-patient (e.g., non emergency hospital visit with stay), emergency room, urgent care facility, specialist, PCP, and home care. In other embodiments, additional channels of care can be employed, including, for example, a pharmacy.

Using BETOS claim codes, each day of service is classified into a respective channel of care. For example, at 504, channel of care is assigned to Inpatient if a M2 or M6 code is present. According to various embodiments, the code M2 can be followed by further elements that provide greater levels of specificity. If M2 or M6 are the first digits of a claim code, a match is found and the day of service is assigned the matching channel of care. Further refinements can be used to include or exclude matching from a given channel of care. In one example, a CPT code of 99291 maps to an M2C code, resulting in a classification of HOSP/IP (hospital/inpatient), but at least sometimes this code is used in ER visits. Thus, classification on certain codes (e.g., 99291) may include additional checks to determine a valid classification. In one example, costs associated with the service can be evaluated to ensure HOSP/IP classification over ER classification—costs for ER visits can be much higher than inpatient.

In other examples, the channel of care is assigned to ER if an M3 code present; channel of care is assigned to Urgent care if a S9083 or S9088 code is present; channel of care is assigned to Specialist if a M1 or a M5B/D code is present and physician specialty is non-PCP; channel of care is assigned to PCP if M1 or M5B/D and physician specialty is PCP; and channel of care is assigned to Home care if a M4 code is present. In other embodiments, CPT codes can be mapped to a channel of care (without or without BETOS codes), and days of service classified accordingly.

At 506, each claim is assigned to a unique day of service. According to one embodiment, claims on non-unique days of service are mapped back to the preceding unique day of service. As discussed, with each claim mapped to a unique day of service defined on a medical provider encounter, each claim is associated to an actual provider encounter. According to one embodiment, each claim is associated with a classification 0: for a claim occurring before the first identified unique day of service in an episode of care and 1-n: for a claim occurring on or after the Nth day of service but before N+1th (where N+1 denotes the next unique day of service in the episode chronology).

Optionally, the medical claims data can be cleaned to remove duplicates and/or non-representative cases. According to one embodiment, cleaning of the data can occur during classification at 504. In some examples, cleaning of the data includes removing episodes with removal of outlier episodes with particularly severe or complicated disease, and/or removing data with incomplete or comorbid situations (comorbid—referring to the presence of more than one medical condition). In one example, data associated with outlier episodes with a particularly severe or complicated disease, incomplete medical conditions, and/or comorbid medical conditions are flagged. In one embodiment, these flags can be created as part of the claims grouping process (e.g., at 502). Once flagged, the claims can be removed from consideration when later calculating probabilities and/or costs.

According to other embodiments, additional claims can be removed including, for example, episodes of care with no professional visit on the first day of care and episodes of care that cannot be mapped back to a specified provider network (i.e., out of network care). In some embodiments, estimation of costs can be limited to specific provider networks. Episodes of care that begin outside of the specified network can be excluded to ensure cost estimates are not skewed.

Process 500 can continue at 508 with classification of each day of service within each episode based on a “fingerprint” of care delivered. The fingerprint of care describes all the elements of care associated with the day of service. Each fingerprint can be compared to others and/or grouped based on respective encoding. Thus, the fingerprint can be referred to as care DNA. In some embodiments, each day of service in an episode is tagged with its unique fingerprint, based on a binary string which indicates the absence or presence of a defined set of services in the episode (on a particular unique day of service).

According to one embodiment, each claim is analyzed to identify whether each one of a series of claim groups are present within the claim. One example binary fingerprint that can be used to classify claims is ordered as follows: Doctor Visit, Anesthesia, Major Surgery, Minor procedure/surgery, ambulatory/outpatient procedure/surgery, Imaging—standard (x-ray), Imaging—advanced (CT, MRI), Imaging—other (moderately complex), Lab test, Functional test (EKG, stress test, Durable medical equipment, and Everything else. Although the order of the groups can be changed in other embodiments, consistency in the fingerprint generation enables direct comparison to other fingerprints and facilitates manipulation of the data via ranking/ordering. Other embodiments can employ any subset of the groupings identified in the above example so long as the groupings include a category for unmatched or everything else.

In one example, claims having BETOS codes are mapped into respective categories as follows: M1-M6 (excluding M5A and M5D): Doctor Visit; P0: Anesthesia, P1-P3: Major surgery; P4, P6, M5D: Minor procedure/surgery; P5, P7-P9: Ambulatory/outpatient procedure/surgery; I1: Imaging, standard (x-ray); I2: Imaging, advanced (CT, MRI); I3-I4: Imaging, other (moderately complex); T1, M5A: Lab test; T2: Functional test (EKG, stress test); D1: Durable Medical Equipment; and O1, Y1, Y2, Z1, Z2: Everything else.

According to one embodiment, classifying each day of service by treatment fingerprint at 508 can include storing a binary representation of the “fingerprint” based on a count of claims in each grouping. In other words, generating a fingerprint includes counting the number of claims that occur on a unique day of service that fall into one of the claims categories. If a category has >0 claims, then the category is present and represented by a (1). If not, the category is absent and represented by (0). For example, a one-day episode of care with a doctor's visit and a lab test will have a fingerprint or “care DNA”=100000001000. Each category and binary value is illustrated for the example (single day with doctor visit and a lab test) as follows:

i. Doctor visit=1

ii. Anesthesia=0

iii. Major surgery=0

iv. Minor procedure/surgery=0

v. Ambulatory/outpatient procedure/surgery=0

vi. Imaging, standard (x-ray)=0

vii. Imaging, advanced (CT, MRI)=0

viii. Imaging, other (moderately complex)=0

ix. Lab test=1

x. Functional test (EKG, stress test)=0

xi. Durable medical equipment=0

xii. Everything else=0

Once execution of process 500 is complete, each episode of care in the medical claims data set is associated with a channel of care, a medical condition, and a fingerprint. Once claims data is stored in a format reflecting the tuple {channel of care, medical condition, and fingerprint} a determination of probability for each treatment path (represented by unique fingerprints for each medical condition and channel) can be determined.

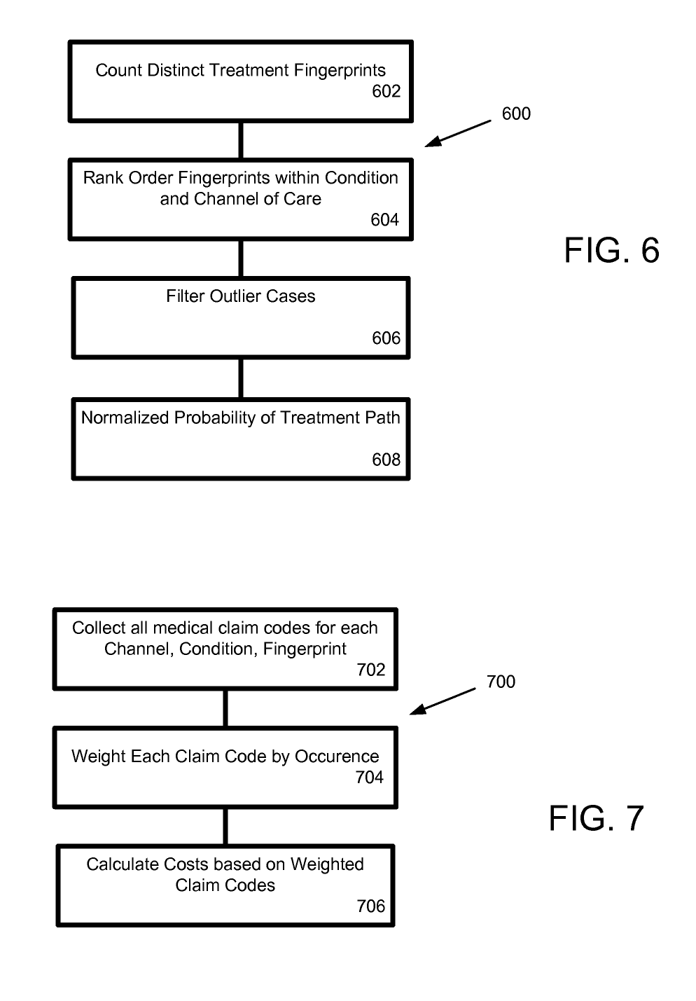

FIG. 6 is an example process 600 for determining a likelihood associated with possible treatment paths. Process 600 can be executed (e.g., by system 100, engine 104, and/or a calculation component) to calculate the statistical probabilities of certain paths of care occurring. For example, process 600 can be used to calculate how likely it is that a patient presenting with a headache to a primary care physician will receive only an office visit versus an office visit and a lab test. In some embodiments, a process for classifying medical claims data can be executed prior to process 600. Alternatively, pre-classified data can be used for execution of process 600 to provide a medical claims dataset tagged with a channel of care, medical condition and a fingerprint. Process 600 begins at 602 with counting distinct treatment fingerprints. For each tuple {channel of care, medical condition, fingerprint}, the number of distinct episode fingerprints are counted based on occurrence in a medical claims dataset. According to one aspect, the probability that a particular medical treatment path occurs when a patient has a headache and goes to a primary care physician can be represented by the equation: P (channel of care=PCP, medical condition=headache, fingerprint=office visit+lab test)=number of episodes (PCP, headache, office visit+lab test)/number of episodes (PCP, headache, *).

The execution of the preceding calculation can be simplified by rank-ordering all fingerprints in a medical condition- and channel-specific episode by their episode count (e.g. at 604). Applying the rank-ordering of step 604 to hypothetical data for a headache/PCP (condition/channel) example shown in FIG. 2: the data includes 110 episodes in total, with 7 fingerprints.

i. PCP, Headache, Doctor Visit=65 episodes

ii. PCP, Headache, Doctor Visit+Lab Test=24 episodes

iii. PCP, Headache, Doctor Visit+Lab Test+EKG=6 episodes

iv. PCP, Headache, Doctor Visit+MRI=5 episodes

v. PCP, Headache, Doctor Visit+Lab Test+MRI=4 episodes

vi. PCP, Headache, Doctor Visit+EKG=3 episodes

vii. PCP, Headache, Doctor Visit+Lab+MRI+EKG=3 episodes

According to one embodiment, outlier values (e.g., fingerprint data occurring above a 90^{th} percentile rank) can be filtered from consideration. Filtering of outlier cases can be executed at 606. Using the data above, the last three fingerprints are removed from consideration.

Once outliers are filtered, the remaining episode fingerprints are as follows

i. P(1000)=65/110=59%

ii. P(1100)=24/110=22%

iii. P(1110)=6/110=5%

iv. P(1001)=5/110=5%

The above example, encodes a simplified fingerprint based on {Doctor Visit, Lab Test, Functional Test, Imaging Test}. If the grouping described above (PCP, Headache, Doctor Visit) were encoded using the twelve group fingerprint example the representation would be P(1000000000000). However, for the purposes of clarity a simplified fingerprint can be used and displayed. In some examples, simplified fingerprints can be used by the system using different grouping and numbers of groupings.

Based on filtering operations, the last three fingerprints (v. vi. and vii.) are eliminated as separate categories. The last three sets of fingerprint are then assigned into an “other” or catchall category. As shown in the graph of FIG. 2, the probability values are normalized for the transition probabilities, which can occur, for example, at 608. For example, given a 5% chance that P(1110) occurs, and a 22% chance that P(1100) occurs, the probability that P(1110) occurs when P(1100) has occurred is 5/22=23%, as shown in FIG. 2 at 214.

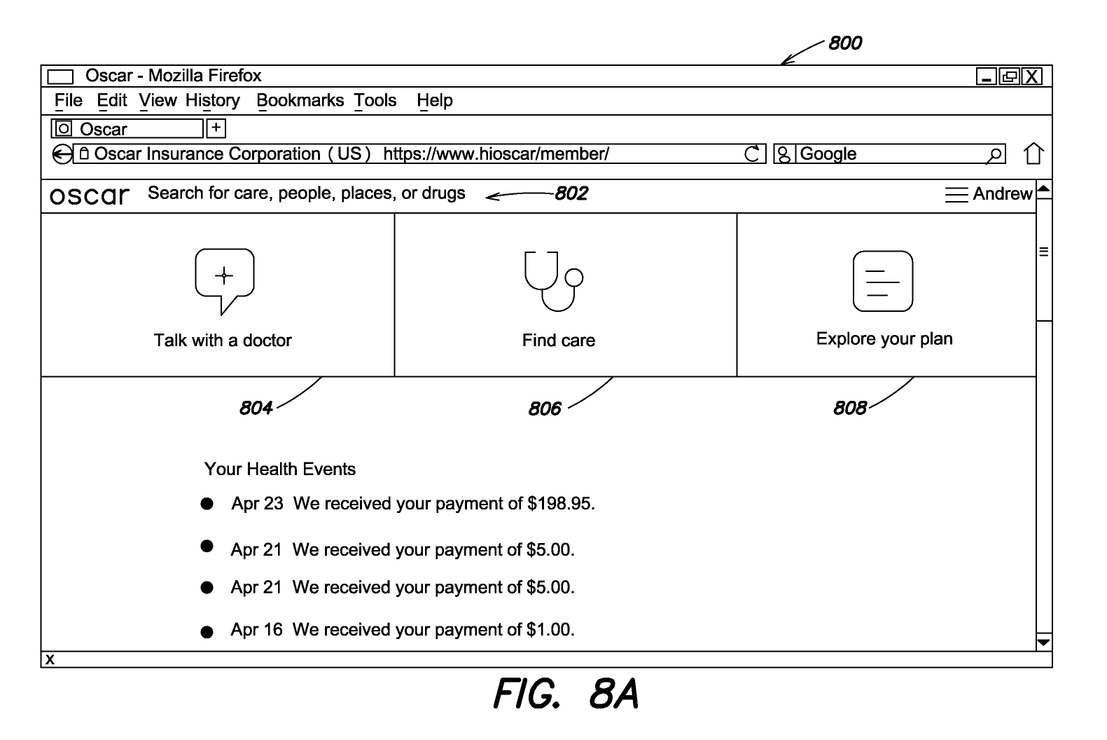

Once probabilities have been assigned to medical claims data, calculation of costs for treatment pathways or care paths can be determined. For example, cost weights can be determined and used to estimate the care paths (e.g., treatment pathways) to provide users a forward-looking estimate of the costs they are facing when utilizing healthcare services. FIG. 7 is an example process 700 for estimating costs of possible treatment pathways. According to one embodiment, process 700 begins at 702 with collecting the set of all medical claims codes that occur as part of respective tuples {channel of care, medical condition, fingerprint}. Once collected the medical claim codes are weighted by occurrence at 704. For example, in the hypothetical example described for headache and PCP above, the medical claims that occur in the fingerprint Doctor Visit+Lab Test are: carcinoembryonic antigen (“CEA”) protein level, microscopic examination for white blood cells, analysis for antibody to Herpes simplex virus, measurement of antibody for rheumatoid arthritis assessment, analysis for antibody, and treponema pallidum. Each one of these codes is a formal medical code used for billing medical services. Thus, each service has a dollar amount associated with each one of the codes. In further embodiments, the information on the location of service at which the service was delivered can also be used to deliver future cost estimates. Each service provided is submitted with a formal code and a location. For example, “analysis for antibody to Herpes simplex virus” might cost $15 at a Labcorp lab, and $100 when done in a lab at the Presbyterian Hospital. All of the associated costs for each claim code are stored within the claims data accessible by the system.

The costs associated with a particular treatment pathway and/or channel of care can be calculated at 706 using the weighted claims codes. In some embodiments, the average cost is calculated based on weighting the codes and place of service associated in a given tuple's (channel, medical condition, fingerprint) set of claims. The costs can be determined for an entire channel of care (e.g., PCP) at 706 by averaging across all providers in that channel of care stored in the medical claims data to derive a per claim code cost. In other embodiments, costs can be established for a single provider by using only the data associated with that provider.

Once the cost estimates are established, for example, by execution of process 700, the results can be displayed with rank-ordered treatment fingerprints. For example, for a particular (medical condition, channel) combination, the treatment paths within the combination can be ranked by frequency of occurrence. For each tuple (medical condition, channel, fingerprint), the cost estimate can be displayed in association with its respective treatment path. Summary data can also be provided to show an overall range of costs for all the fingerprints within a medical condition and channel.

### Example User Environment and User Interfaces

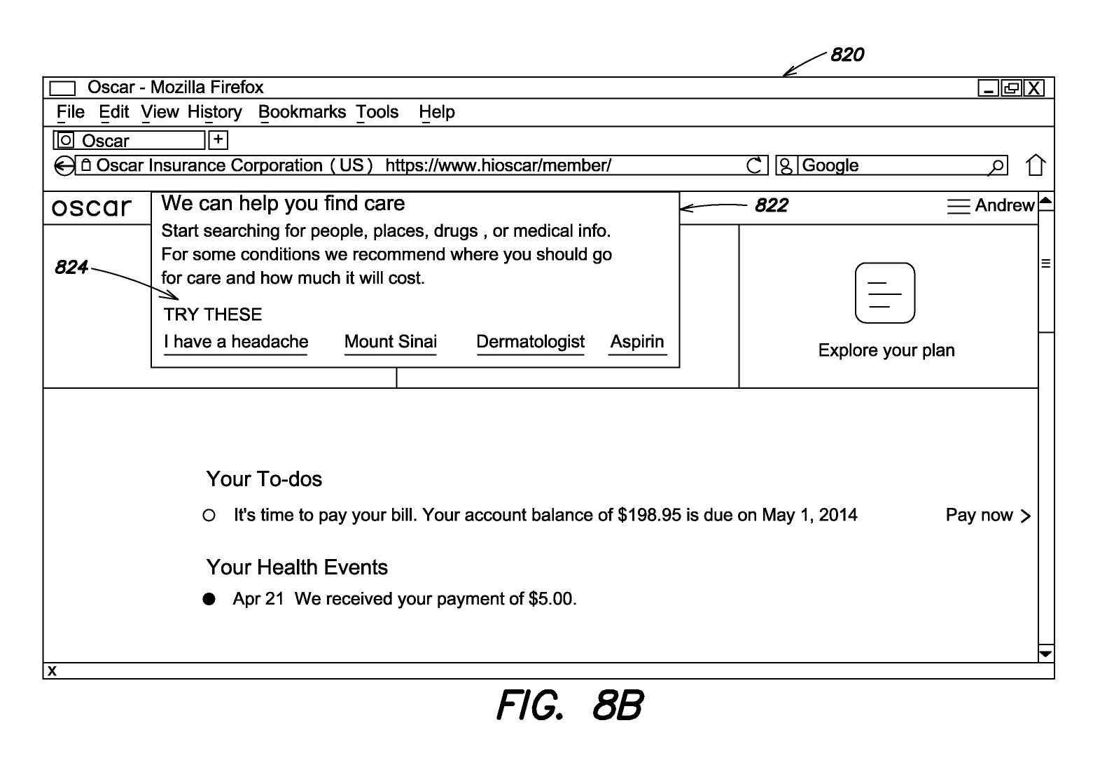

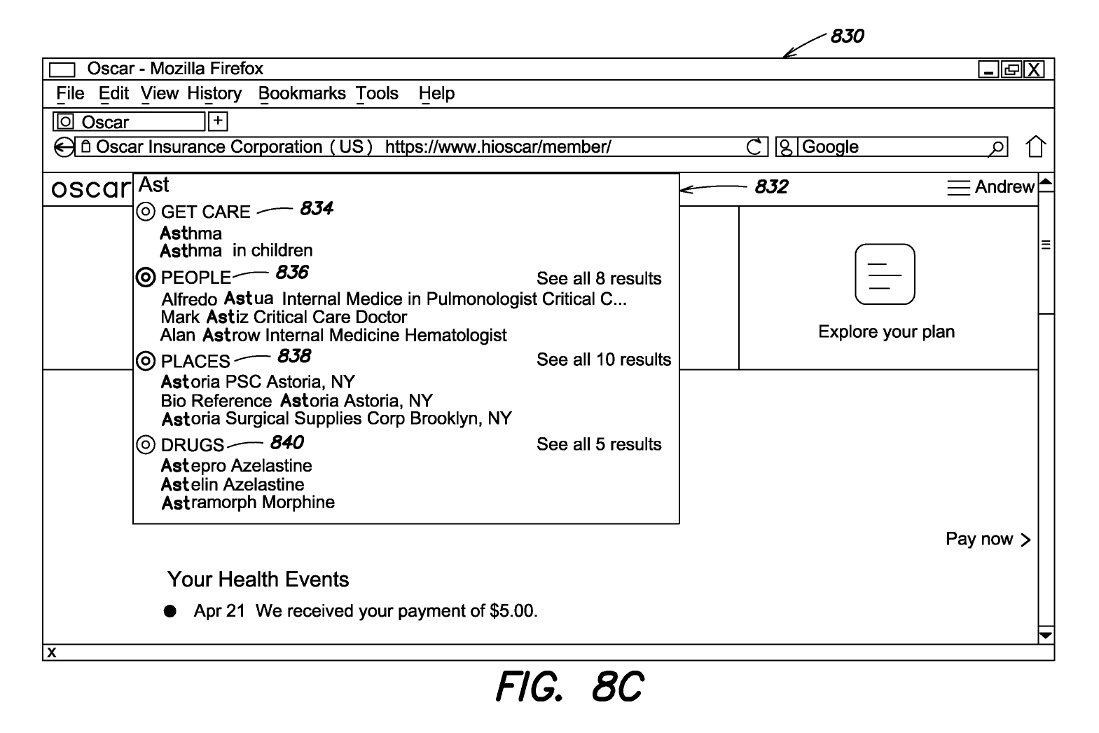

According to one aspect, users in need of or contemplating medical services can access a system for estimating medical costs to search on their medical condition and receive cost estimates. In some embodiments, users can access the system online, for example, via a web page. In further embodiments, the users can receive cost estimates that are based on the channel of care each user selects. In some examples, the cost estimates can be refined based on the user's location, and even user selection of specific providers (including, for example, their own PCP). FIGS. 8-13 are screen captures of example user interfaces provided by the system (e.g., system 100, 302, estimation engine 104, and/or UI component 112).

FIG. 8A is an example screen capture of an example user interface display 800. UI display 800 is welcoming screen presented by the system in response to a user login. UI display 800 includes a search interface 802 and navigation options at 804, 806, and 808. The navigation options are configured to provide access to at least some of the main functions associated with the website. For example, selection of 804 is configured to schedule a call with a physician. Once selected in the UI display, the user can be contacted by a physician according to their contact preferences. Selection of 808 causes the system to transition the user to information regarding their health plan and available services. Selection of 804, activates the search interface 802. Activation of the search interface 802 causes the system to display information on what information can be searched within the system.

FIG. 8B shows an example UI display 820 having an activated search interface 822. The activated search interface 822 can display text information describing search options, and in some examples provide example searches to try (e.g., at 824). In some embodiments, activating the search interface can be accomplished by selecting a navigation option (e.g., 804, FIG. 8A) or by selecting the search interface in the UI display. The search interface can be configured to accept text input from users and display potential matches to users as input is received.

FIG. 8C shows an example UI display 830 of input text characters within a search interface 832. According to some embodiments, the system, search interface and/or a search component is configured to receive the text input and show potential search operations to user as text characters are input. The potential search operations can be generated using type-ahead matching functions to facilitate searching by the user. According to some embodiments, the search interface is configured to organize displays of potential matches based on information categories. For example, the information categories can include any one or more of “Get Care,” “People,” “Places,” and “Drugs.” If matches are generated in any one or more of the categories the top matches for each category are displayed (e.g., at 834, 836, 838, and 840). The information categories can be associated with a display precedence such that specific categories are displayed with a higher precedence (e.g., closer to the top of the display screen), when present.

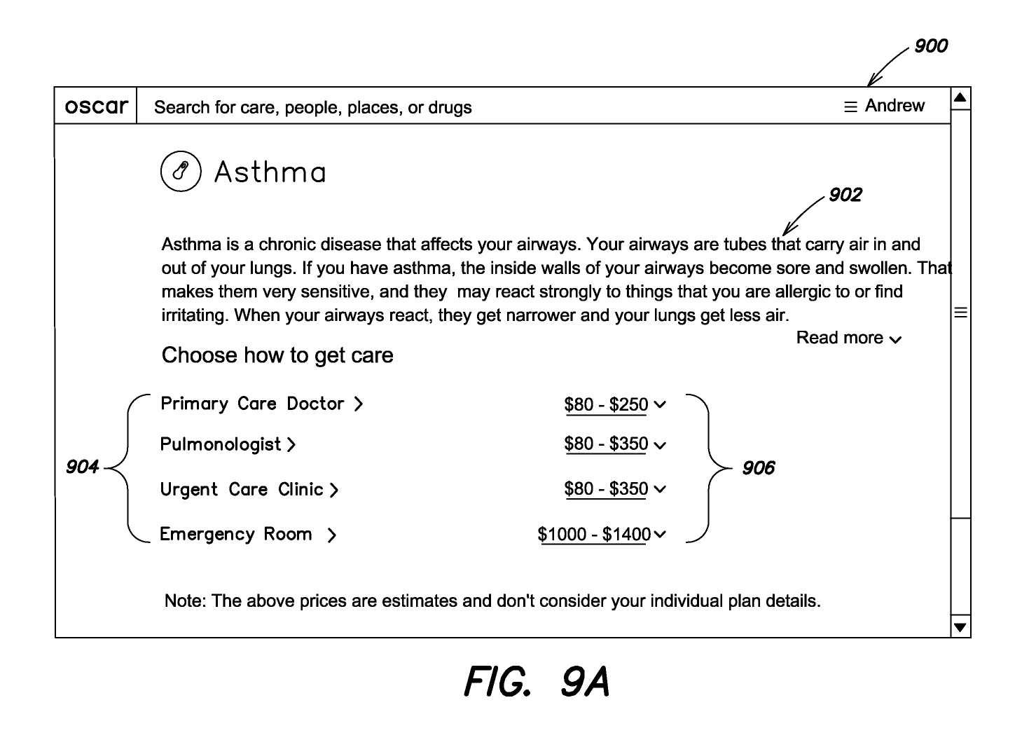

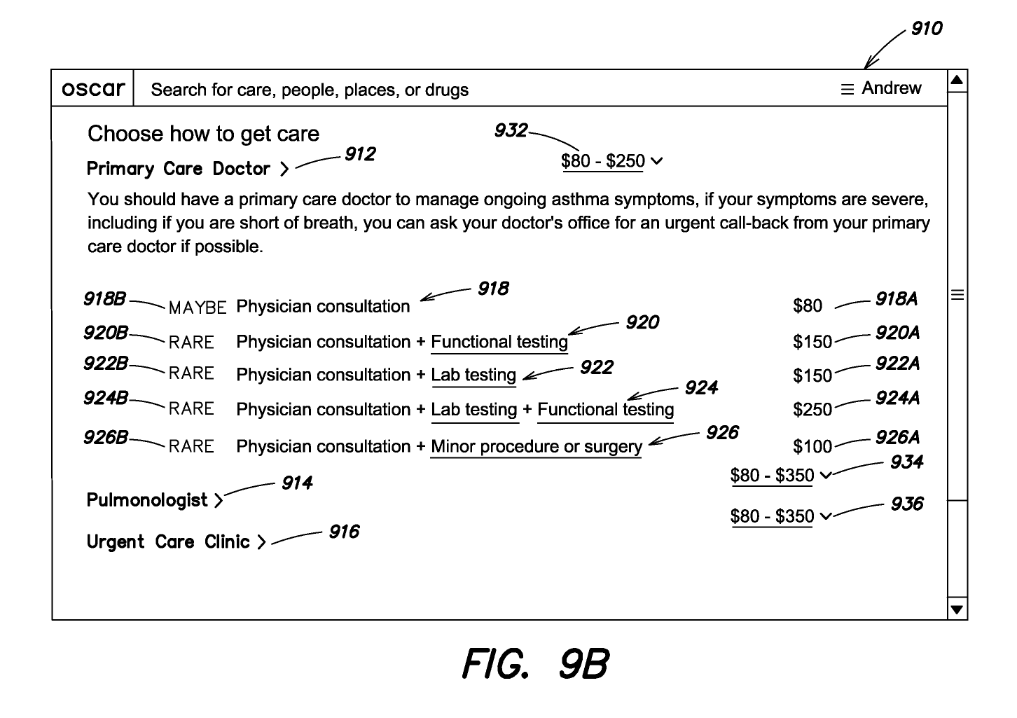

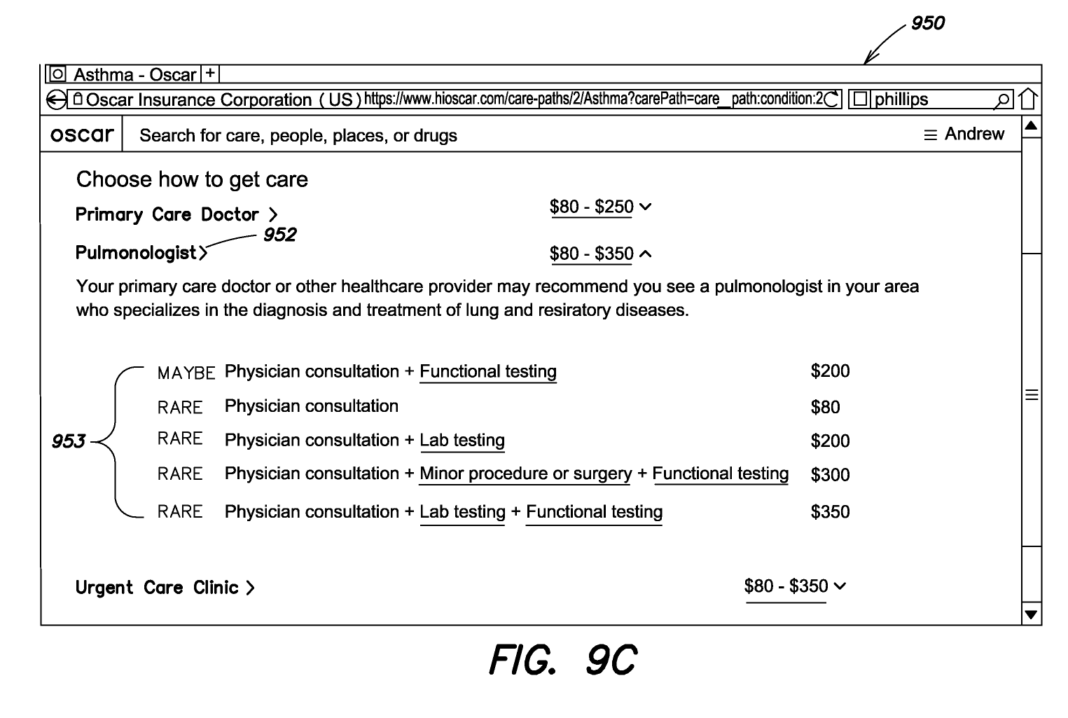

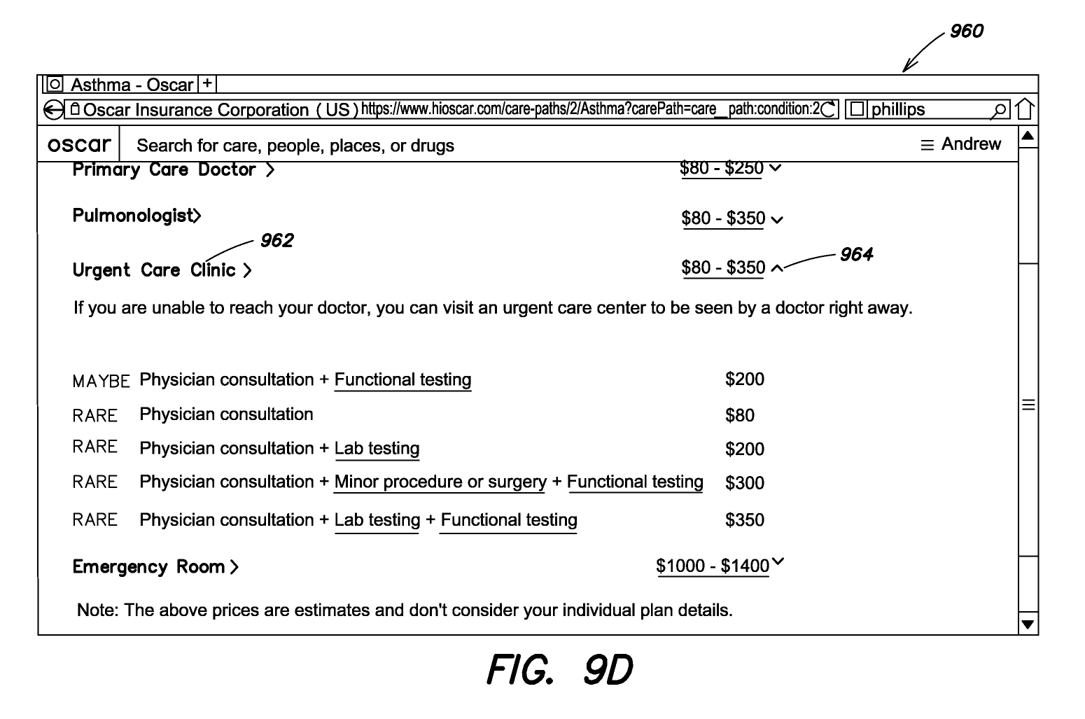

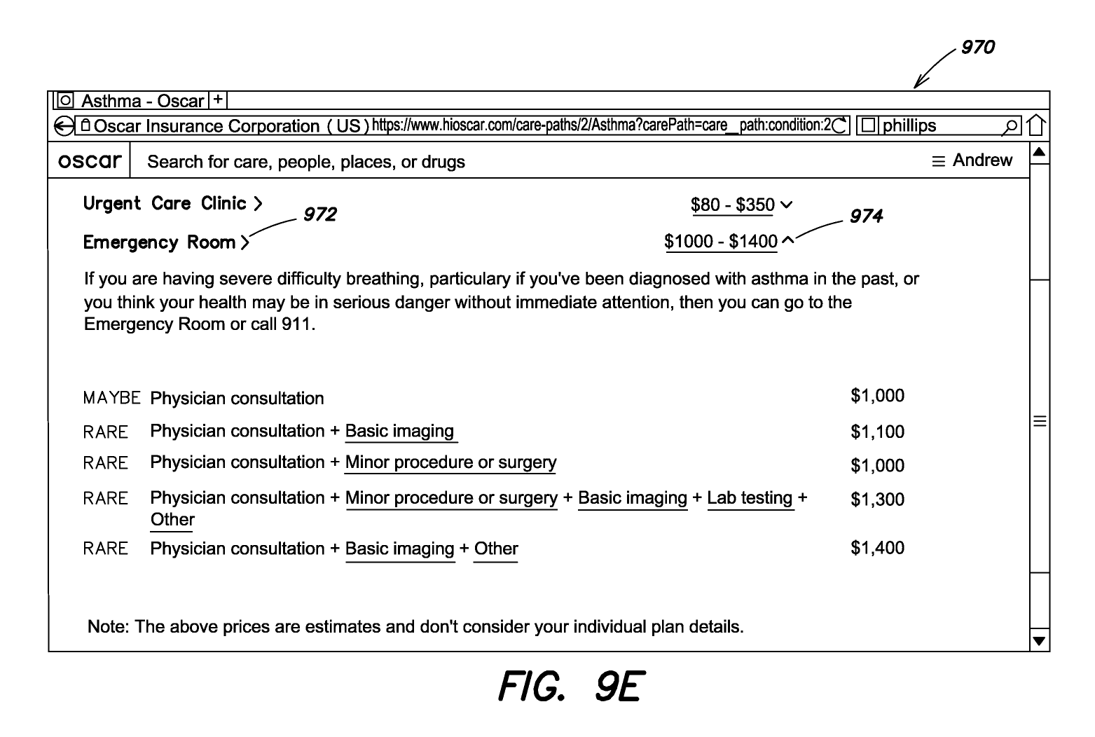

According to one example, the user is searching for care based on having asthma. Responsive to the complete user input or selection of “Asthma,” (e.g. based on selection of Asthma in the “Get Care” category (834)), the system is configured to transition to a care display showing detailed information for the user input medical condition—asthma. FIG. 9A is an example UI display 900 for detailed information on treatment options for asthma. Shown in display 900 is a description of the medical condition at 902. According to some embodiments, responsive to the search input, the system determines channels of care matching the search input and potential treatment pathways that any services for a patient may take. In display 900, the matching channels of care are displayed at 904. Each channel of care can be associated with an estimated cost range for the channel of care (e.g., at 906). For example, within each channel of care potential treatments are identified and used to derive an associated cost. The associated costs are used to generate the ranges associated with each channel of care. UI display 900 can be configured to provide additional information on potential costs. For example, each channel of care displayed at 904 can be responsive to selection in order to expand the display to reveal additional detail regarding costs.

FIG. 9B is an example UI display 910 for providing detailed cost estimate information. Shown at 912 is a first channel of care associated with user medical condition—asthma. Responsive to selection at 932, the UI 910 can transition between an unexpanded view (not shown) and an expanded view of the first channel of care. The expanded view provides detail on each potential treatment pathway (e.g., 918, 920, 922, 924, and 926), associated cost (e.g., 918A, 920A, 922A, 924A, and 926A) and can include information on a respective likelihood the treatment will occur (e.g., 918B, 920B, 922B, 924B, and 926B). As discussed above, various processes can be executed to determine potential treatment pathways, a likelihood that a given pathway will occur based on a selected medical condition, and respective costs. The information represented by the cost range associated with a channel of channel can be revealed in the expanded view on any displayed channel of care (e.g., 912, 914, and 916). Selection of 934 or 936 transitions the display between an unexpanded view and an expanded view (not shown).

FIG. 9C is an example UI display 950 showing an expanded view of a specialist channel of care (e.g., pulmonologist 952). As discussed above, the expanded view provides detailed information on potential treatment pathways within a channel of care (e.g., at 953). Various treatment pathways are displayed with their associated costs and likelihood. FIG. 9D is an example UI display 960 showing an expanded view of an Urgent Care Clinic channel of care (962). UI display 960 includes a selector 964 configured to transition between expanded and unexpanded views. FIG. 9E is an example UI display 970 showing an expanded view of an Emergency channel of care (972). UI display 970 includes a selector 964 configured to transition between expanded and unexpanded views.

Various embodiments of an estimation system include additional options to educate and facilitate utilization of medical services. In some examples, the estimation system is configured to tailor cost estimates and information provided to a user based on a user location. The user location can be accessed from user profile information. In other examples, the user location can be captured from a device used to access the system (e.g., smart phone with location based services or location hardware). In yet other examples, a user location can be determined based on browser information obtained as the user accesses a web site hosted by the system.

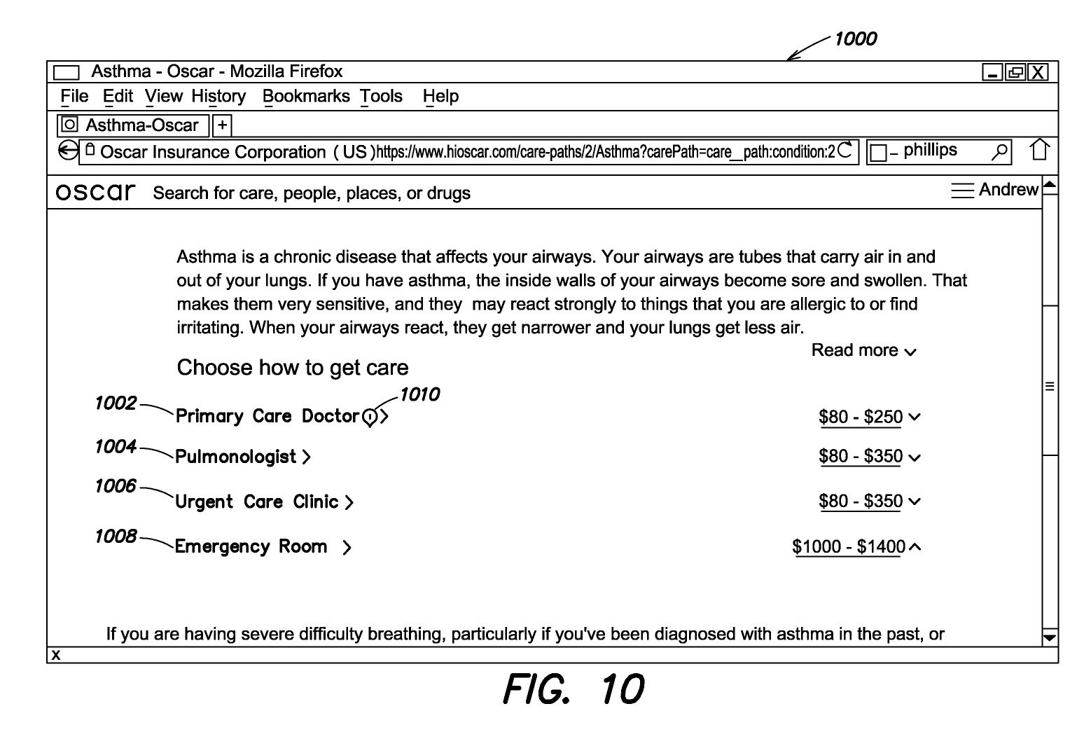

FIG. 10 is an example user interface display 1000 of cost estimates matching a user input medical condition—e.g., asthma. In some embodiments, each channel of care that is displayed and matching the user input condition is configured to respond to user selection. In some embodiments, each displayed channel of care (e.g., 1002, 1004, 1006, and 1008) is configured to display a map pin or map indicator responsive to a UI pointer (e.g., mouse arrow) hovering over the respective text displayed for each channel of care (e.g., hovering a mouse pointer at 1002 “Primary Care Doctor”). At 1010, a map pin is displayed next to “Primary Care Doctor” responsive to hovering. Other map pin displays can be visualized responsive to hovering over the other respective channels of care. According to one embodiment, the map pin 1010 is configured to transition the system to a map based display of primary care physicians proximate to the system determined user location (e.g., device location, web access location, user profile location, etc.). Alternatively, each channel of care display can also be configured to transition the system to a map based display of providers within the respective channel of care (e.g., specialists, emergency room facilities, urgent care clinics, etc.).

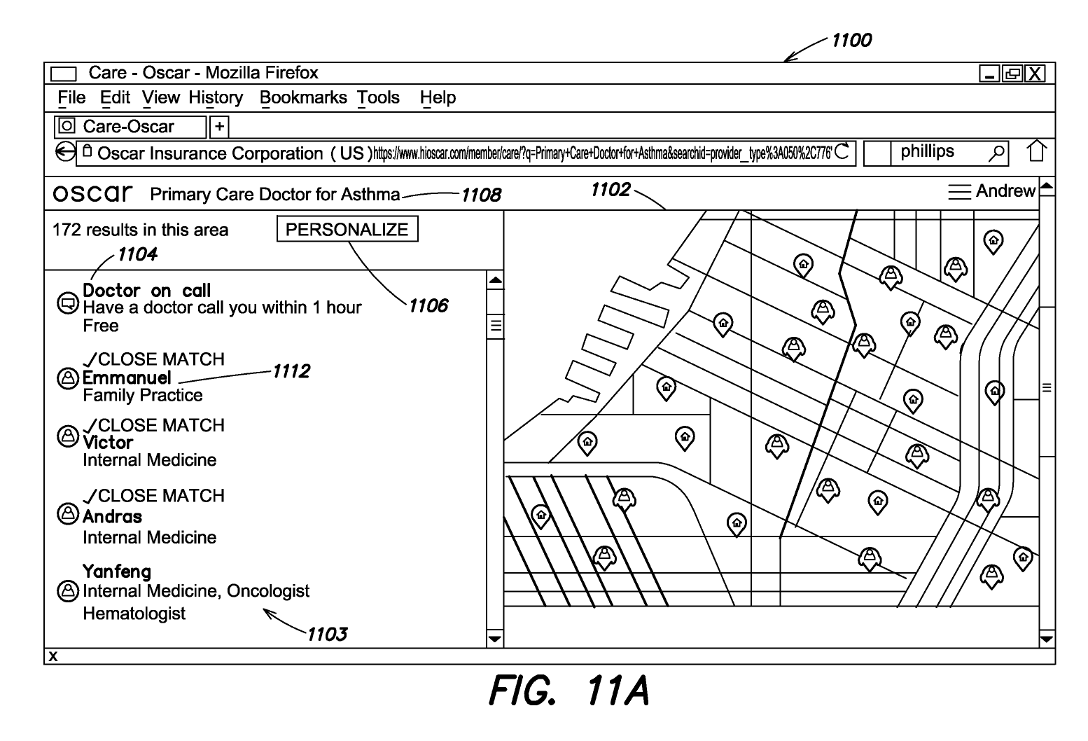

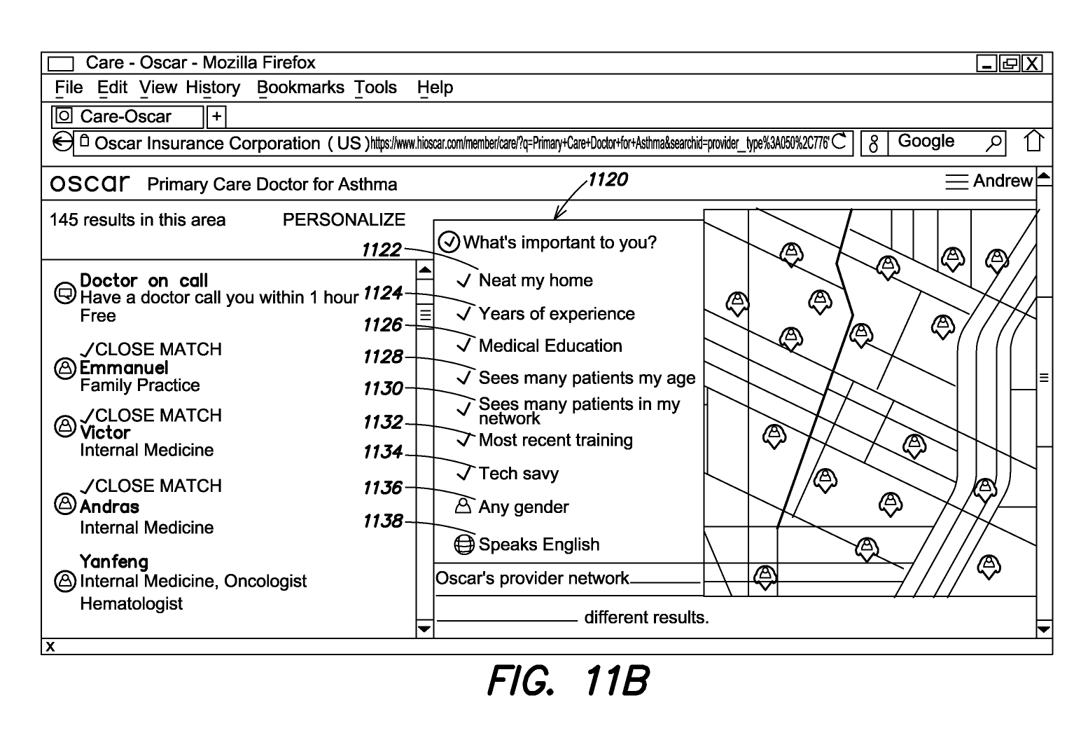

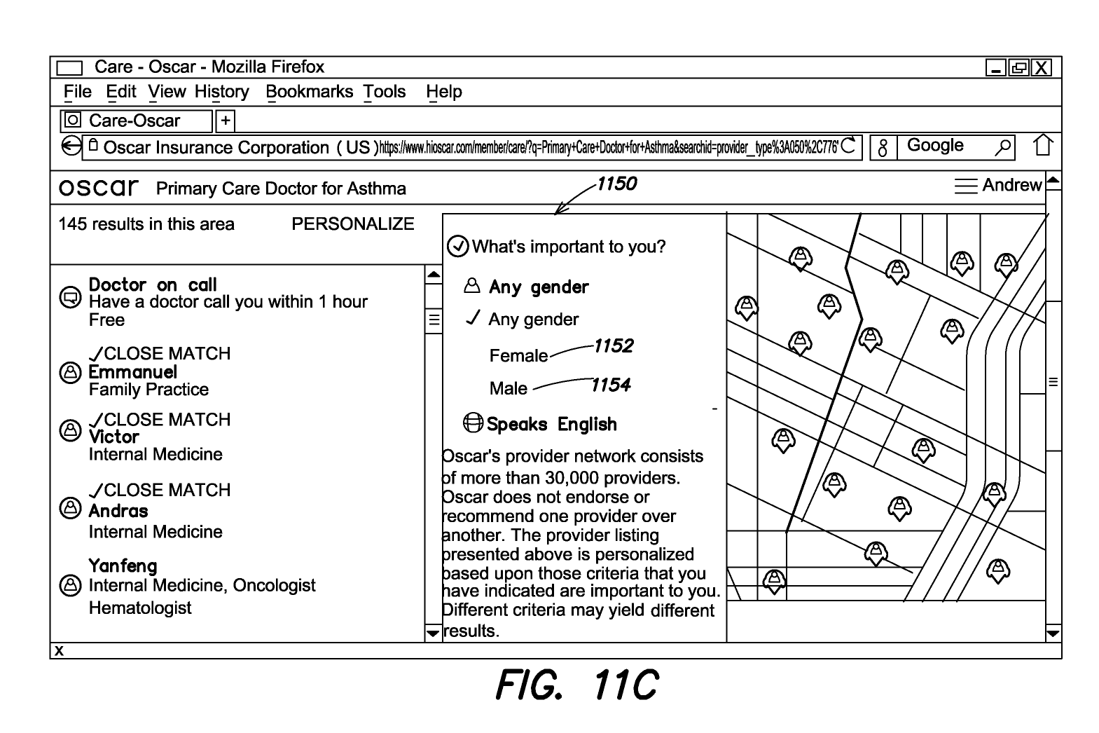

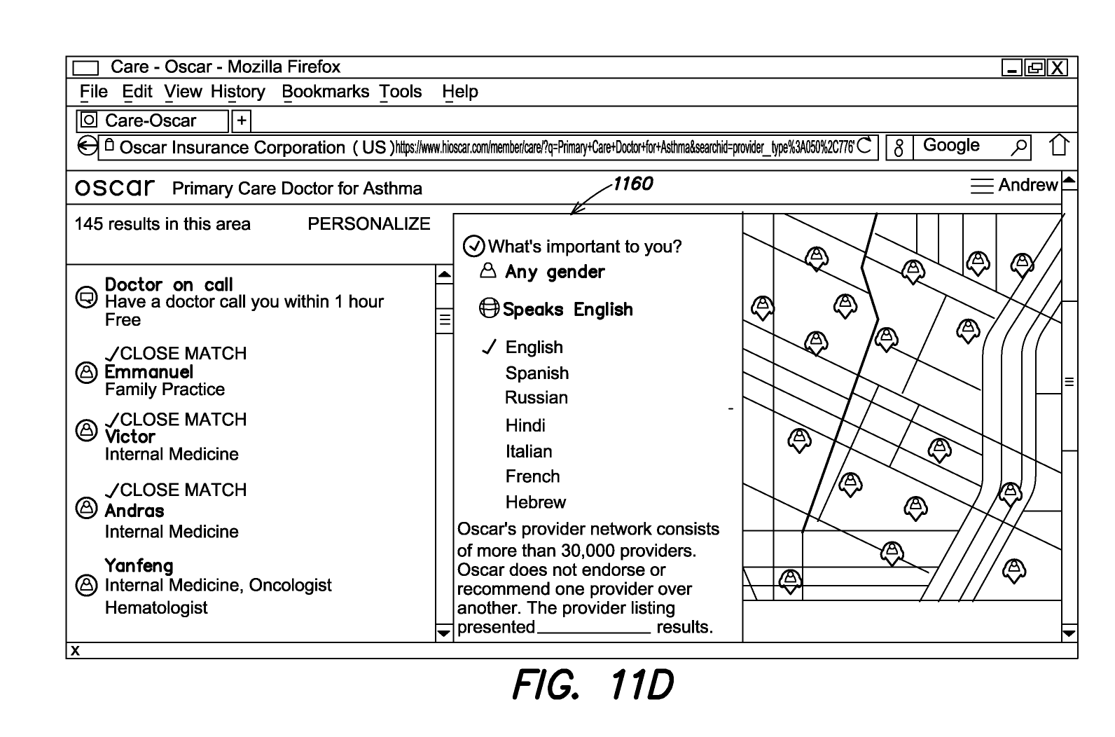

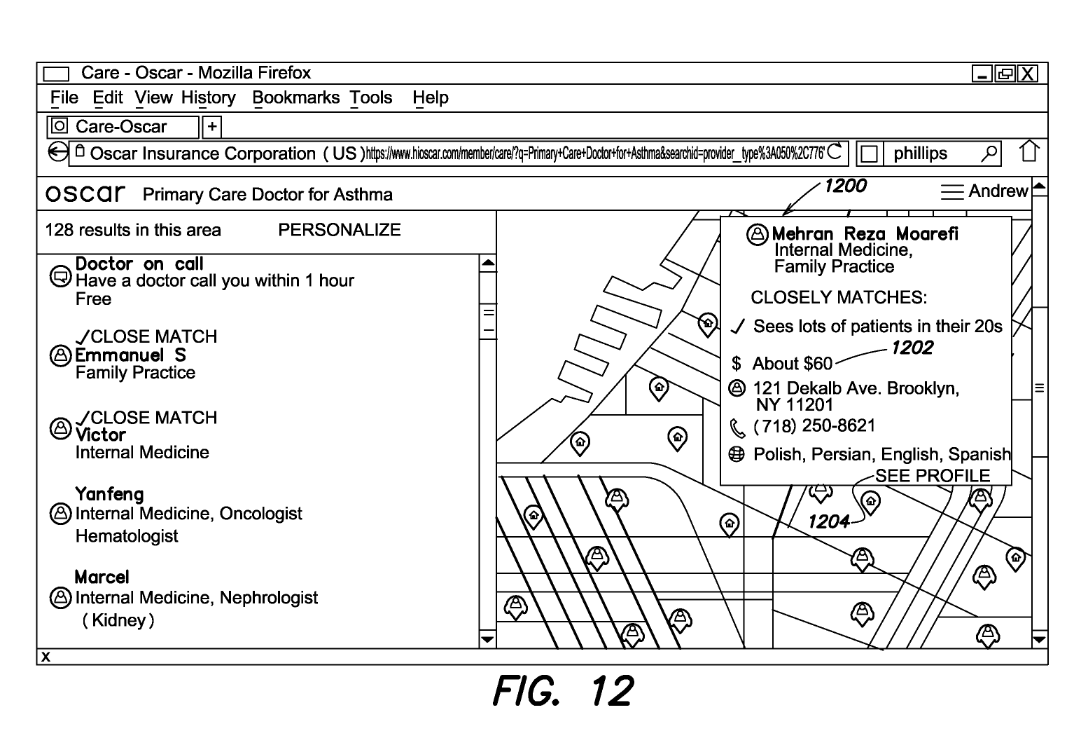

FIG. 11A is an example user interface display 1100, generated by the system configured to provide a map based interface for accessing primary care physicians. UI display 1100 can be organized into multiple portions and/or display areas. According to one embodiment, UI display 1100 includes a map interface portion 1102 where each provider within a channel of care is displayed as a map pin at a respective location and a list portion 1103 where information on individual providers within the channel of care are displayed textually. For example, in the primary care doctor channel, each primary care physician or primary care facility proximate to the user's location is displayed as a map pin (e.g., at 1110). Selection of either the pin (e.g., 1110) or one of information displays (e.g., 1112) in UI display 1100 is configured to display provider specific information (discussed in greater detail below with respect to FIG. 12). According to some embodiments, UI display 1100 provides users a number of tools to assist in connecting with medical services. For example, within the display of providers the system can embed an option configured to provide access to an on call doctor. Responsive to selection of the first displayed option (e.g., 1104) of the list section 1103, the user can arrange a call from their own doctor or an on duty physician. In further embodiments, the UI display 1100 displays options for users to refine their selection of, for example, a primary care doctor (e.g., at 1108). At 1106, the UI display 1100 includes a personalize tool 1106. The personalize tool 1106 can be configured to display one or more preference selections to the user responsive to selection in the UI display 1100.

FIG. 11B is an example overlay display 1120 for selecting filtering options for narrowing provider options (e.g., primary care physicians) in a channel of care. According to one embodiment, the overlay display can be rendered over other displays generated by the system (e.g., 1100). In some examples, the overlay display 1120 can provide a plurality of filter options (e.g., 1122—near my home; 1124—years of experience; 1126—medical education; 1128—sees patients my age; 1130—sees patients in my network; 1132—most recent training; and 1134—tech savvy, among other options). According to one embodiment, selection of “Any Gender” (1136) and/or “Speaks English” (1138) are configured to expand options for either category.

FIG. 11C illustrates an expanded view 1150 for “Any Gender.” The expanded view 1150 enables users to select a gender preference (e.g., female—1152, male—1154). Responsive to selection of a preference, the system is configured to limit the display of matching providers. In some embodiments, the cost estimations made by the system can be modified to account for user entered preferences. For example, rather than develop estimate models based on all medical claims and claim codes for a channel of care and treatment options, the medical claims and/or claim codes can be limited to services provided by physicians matching an input gender preference, language preferences, and/or any preference specified by the user.

FIG. 11D illustrates an expanded view 1160 for “Speaks English.” The expanded view 1160 enables users to select a speaking language preference for a medical service provider. Provided by way of example (and not limitation) some languages that the user may select include Hebrew, French, Italian, Hindi, Russian, Spanish, English, etc.

FIG. 12 is an example overlay display 1200 for conveying provider specific information. According to one embodiment, responsive to selection of a specific provider (e.g., in list portion 1103 or map interface portion 1102), an overlay display of provider specific information can be displayed. In one example, a provider specific cost estimate can be displayed at 1202 based on the channel of care, medical condition, and cost estimates tailored to the selected physician. Other provider information can be provided (e.g., name, address, phone, languages, etc.). In some embodiments, where the user has indicated a provider preference (e.g., UI displays 1120, 1150, and/or 1160), the provider specific information can include matching preference information. Further information on the provider can be accessed by selecting “See Profile” (e.g., at 1204).

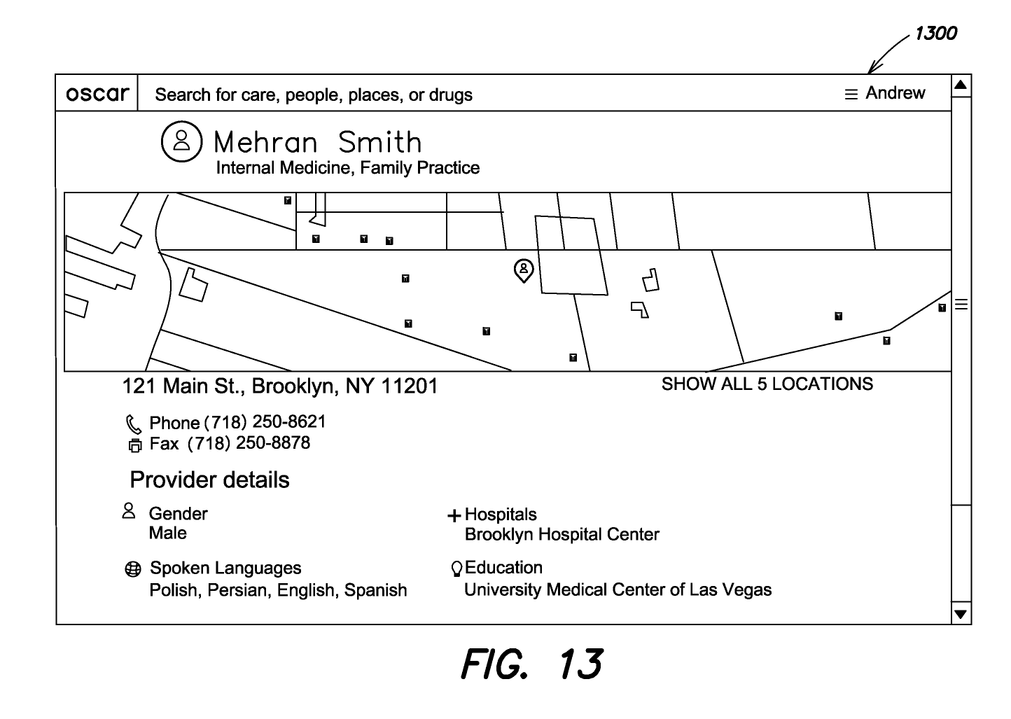

FIG. 13 is an example display 1300 for provider profile information. The profile information can include demographic information on the provider (e.g., name, location, multiple location, phone, fax, gender, spoken languages, practice hospitals, hospitals with surgical privileges, education, recent training, common patient demographic, etc.). According to other embodiments, other UI displays can be generated by the system to convey medical cost information and/or tailor medical cost estimates based on location, provider preference, etc.

### Example System Architecture

Referring to FIG. 14, there is illustrated a block diagram of a distributed computer system 1400, in which various aspects and functions of the present disclosure are practiced. As shown, the distributed computer system 1400 includes one or more computer systems that exchange information. More specifically, the distributed computer system 1400 includes specially configured computer systems 1402, 1404 and 1406. As shown, the computer systems 1402, 1404 and 1406 are interconnected by, and may exchange data through, a communication network 1408. For example, system engines, system components, subsystems, and/or modules can be implemented on 1402, which can communicate with other systems (1404-1406), which operate together to provide the functions and operations as discussed herein.

In some embodiments, the network 1408 may include any communication network through which computer systems may exchange data. To exchange data using the network 1408, the computer systems 1402, 1404 and 1406 and the network 1408 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS14, JSON, SOAP, CORBA, REST and Web Services. To ensure data transfer is secure, the computer systems 1402, 1404 and 1406 may transmit data via the network 1408 using a variety of security measures including, for example, TLS, SSL or VPN. While the distributed computer system 1400 illustrates three networked computer systems, the distributed computer system 1400 is not so limited and may include any number of computer systems (e.g., laptops, desktops, etc.) and computing devices (e.g., smart phones, portable computers, netbooks, etc.) networked using any medium and communication protocol.

As illustrated in FIG. 14, the computer system 1402 includes at least one processor 1410, a memory 1412, a bus 1414, an interface 1416 and data storage 1418. To implement at least some of the aspects, functions and processes disclosed herein, the processor 1410 performs a series of instructions that result in manipulated data. The processor 1410 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 1410 is connected to other system components, including one or more memory devices 1412, by the bus 1414.

The memory 1412 stores programs and data during operation of the computer system 1402. Thus, the memory 1412 may be a relatively high performance, volatile, random access memory such as a dynamic random access memory (DRAM) or static memory (SRAM). However, the memory 1412 may include any device for storing data, such as a disk drive or other non-volatile storage device. Various examples may organize the memory 1412 into particularized and, in some cases, unique structures to perform the functions disclosed herein. These data structures may be sized and organized to store values for particular data and types of data.

Components of the computer system 1402 are coupled by an interconnection element such as the bus 1414. The bus 1414 may include one or more physical busses, for example, busses between components that are integrated within the same machine, but may include any communication coupling between system elements including specialized or standard computing bus technologies such as IDE, SCSI, PCI and InfiniBand. The bus 1414 enables communications, such as data and instructions, to be exchanged between system components of the computer system 1402.

The computer system 1402 also includes one or more interface devices 1416 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1402 to exchange information and to communicate with external entities, such as users and other systems.

The data storage 1418 includes a computer readable and writeable nonvolatile, or non-transitory, data storage medium in which instructions are stored that define a program or other object that is executed by the processor 1410. The data storage 1418 also may include information that is recorded, on or in, the medium, and that is processed by the processor 1410 during execution of the program. More specifically, the information may be stored in one or more data structures specifically configured to conserve storage space or increase data exchange performance. For example, the data storage can be optimized to store treatment fingerprints, process the binary encoded data structures, and return results from the accessed treatment fingerprints.

The instructions stored in the date storage may be persistently stored as encoded signals, and the instructions may cause the processor 1410 to perform any of the functions described herein. The medium may be, for example, optical disk, magnetic disk or flash memory, among other options. In operation, the processor 1410 or some other controller causes data to be read from the nonvolatile recording medium into another memory, such as the memory 1412, that allows for faster access to the information by the processor 1410 than does the storage medium included in the data storage 1418. The memory may be located in the data storage 1418 or in the memory 1412, however, the processor 1410 manipulates the data within the memory, and then copies the data to the storage medium associated with the data storage 1418 after processing is completed. A variety of components may manage data movement between the storage medium and other memory elements and examples are not limited to particular data management components. Further, examples are not limited to a particular memory system or data storage system.

Although the computer system 1402 is shown by way of example as one type of computer system upon which various aspects and functions may be practiced, aspects and functions are not limited to being implemented on the computer system 1402 as shown in FIG. 14. Various aspects and functions may be practiced on one or more computers having different architectures or components than that shown in FIG. 14. For instance, the computer system 1402 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1402 may be a computer system including an operating system that manages at least a portion of the hardware elements included in the computer system 1402. In some examples, a processor or controller, such as the processor 1410, executes an operating system. Examples of a particular operating system that may be executed include a Windows-based operating system, such as, Windows NT, Windows 2000 (Windows ME), Windows XP, Windows Vista, Windows 7 or 8 operating systems, available from the Microsoft Corporation, a MAC OS System X operating system available from Apple Computer, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular operating system.

The processor 1410 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C# (C-Sharp), Objective C, or Javascript. Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements or components, e.g., specialized hardware, executable code, data structures or data objects, that are configured to perform the functions described herein. In some embodiments, the operations and/or function discussed above can be implemented as a distributable application or “app” for purchase and/or download from an application store.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A system for estimating health care costs, the system comprising:
at least one processor operatively connected to a memory;
an analysis component, executed by the at least one processor, configured to determine weight values associated with one or more treatment options from historical medical information, and to generate one or more treatment paths, each treatment path including one or more treatment options; and
a calculation component, executed by the at least one processor, configured to calculate an estimated cost associated with the one or more treatment options, based on, at least in part, the weight values and the one or more treatment paths.

2. The system of claim 1, wherein the analysis component is further configured to identify the one or more treatment paths including the one or more treatment options based on grouping medical condition information with the one or more treatment options.

3. The system of claim 2, wherein the analysis component is further configured to rank the one or more treatment paths based on a respective probability that the medical condition information requires the treatment option.

4. The system of claim 2, wherein the analysis component is further configured to assign the historic medical information to an episode of care, and within each episode of care, and to assign the historic medical information to unique days of service.

5. The system of claim 4, wherein the analysis component is further configured to identify the one or more treatment paths based, at least in part, on the unique days of service.

6. The system of claim 5, wherein the analysis component is further configured to associate the historic medical information to a channel of care and a medical condition.

7. The system of claim 6, wherein the analysis component is further configured to identify the one or more treatment paths based, at least in part, on the channel of care and the medical condition.

8. The system of claim 1, further comprising a database of medical claims and medical condition information.

9. The system of claim 8, wherein the database of the medical claims and the medical condition information is organized based on a medical condition, a channel of care, and a treatment fingerprint.

10. The system of claim 1, wherein the calculation component is further configured to calculate the estimated cost based on the weight values applied to an insurance provider fee schedule.

11. The system of claim 1, wherein the calculation component is further configured to generate a plurality of treatment options based on an association between a medical condition entered by the user and a treatment option.

12. The system of claim 11, wherein the calculation component is further configured to generate the estimated cost associated with the one or more treatment options as a range of costs associated with a channel of care.

13. The system of claim 12, wherein the calculation component is further configured to generate the estimated cost for a plurality of channels of care.

14. The system of claim 13, wherein the calculation component is further configured to generate the estimated cost for a plurality of respective treatment paths within each of the plurality of channels of care.

15. A computer implemented method for estimating health care costs, the method comprising:
determining, by a computer system, weight values associated with one or more treatment options from historical medical information;
generating, by the computer system, one or more treatment paths, each treatment path including one or more treatment options; and
calculating, by the computer system, an estimated cost associated with the one or more treatment options, based on, at least in part, the weight values and the one or more treatment paths.

16. The method of claim 15, wherein generating the one or more treatment paths, each treatment path including one or more treatment options, includes generating the one or more treatment paths based on grouping medical condition information with the one or more treatment options.

17. The method of claim 16, further comprising ranking the one or more treatment paths based on a respective probability that the medical condition information requires the treatment option.

18. The method of claim 16, further comprising assigning the historic medical information to an episode of care, and within each episode of care assigning the historic medical information to unique days of service.

19. The method of claim 18, further comprising identifying the one or more treatment paths based, at least in part, on the unique days of service.

20. The method of claim 19, further comprising associating the historic medical information to a channel of care and a medical condition.

21. The method of claim 20, wherein identifying the one or more treatment paths includes identify the one or more treatment paths based, at least in part, on the channel of care and the medical condition.

22. The method of claim 15, further comprising accessing a database of medical claims and medical condition information.

23. The method of claim 22, further comprising organizing the medical claims and the medical condition information within the database based on a medical condition, a channel of care, and a treatment fingerprint.

24. The method of claim 15, further comprising calculating the estimated costs based on the weight values applied to an insurance provider fee schedule.

25. The method of claim 15, further comprising generating a plurality of treatment options based on an association between a medical condition entered by the user and a treatment option.

26. The method of claim 25, wherein calculating, by the computer system, the estimated cost associated with the one or more treatment options includes generating the estimated cost associated with the one or more treatment options as a range of costs associated with a channel of care.

27. The method of claim 26, wherein calculating, by the computer system, the estimated cost associated with the one or more treatment options includes generating the estimated cost for a plurality of channels of care.

28. The method of claim 15, wherein calculating, by the computer system, the estimated cost associated with the one or more treatment options includes generating the estimated cost for a plurality of respective treatment paths within each of the plurality of channels of care.
